(19) United States
(12) Patent Application Publication
(10) Pub. No.: US 2014/0125992 A1
(43) Pub. Date: May 8, 2014

(54) OPTICAL COHERENCE TOMOGRAPHY APPARATUS AND OPTICAL COHERENCE TOMOGRAPHY METHOD

(71) Applicant: CANON KABUSHIKI KAISHA, Tokyo (JP)

(72) Inventor: Takefumi Ota, Tucson, AZ (US)

(73) Assignee: CANON KABUSHIKI KAISHA, Tokyo (JP)

(21) Appl. No.: 14/068,055

(22) Filed: Oct. 31, 2013

(30) Foreign Application Priority Data
Nov. 2, 2012 (JP) 2012-242529

(51) Int. Cl. G01B 9/02

(52) U.S. Cl. CPC G01B 9/02091
USPC 356/497

(57) ABSTRACT

The optical coherence tomography apparatus includes: a light source unit; a branch unit for branching light output from the light source unit into measurement light and reference light; an interference unit for causing reflection, the reflection being light returned from an object, which is illuminated with the measurement light, to interfere with the reference light; and a detection unit for receiving interference light from the interference unit so as to detect an intensity of the interference light. The optical coherence tomography apparatus acquires a tomographic image of the object based on the intensity of the interference light detected by the detection unit. The interference unit outputs first and second interference light having interference components having phases mutually different by π. The first and second interference light output from the interference unit reaches the detection unit so that a time gap is generated between the first and second interference light.

### BACKGROUND OF THE INVENTION

1. Field of the Invention

The present invention relates to an optical coherence tomography apparatus and an optical coherence tomography method for acquiring tomographic information of an object to be measured based on an optical interference signal.

2. Description of the Related Art

There has been proposed an optical coherence tomography (OCT) apparatus for acquiring tomographic information of an object to be measured based on an optical interference signal. In the OCT, light output from a light source is split into two or more beams, and one of the beams is set as reference light, while the other beam is set as illumination light for illuminating a sample. Scatter light or reflection light returns from the sample that is illuminated with the illumination light, and an optical interference signal is acquired through interference between the reflection light and the reference light described above.

As the OCT, there has been proposed a time-domain OCT (TD-OCT) for acquiring tomographic information based on the intensity of the interference signal acquired by changing an optical path length of the reference light. Further, there has been proposed a Fourier-domain optical coherence tomography (FD-OCT) for acquiring a tomographic information signal of the object to be measured by acquiring an optical spectrum interference signal and performing Fourier transform on the optical spectrum interference signal thus acquired.

Further, two methods are proposed for the FD-OCT.

The first method is called a swept-source optical coherence tomography (SS-OCT) as disclosed in Japanese Patent Application Laid-Open No. 2011-221043. In this method, a wavelength-swept light source for outputting light having a temporally changing wavelength is used to acquire the optical spectrum interference signal that is developed temporally.

The second method of the FD-OCT is called a spectral-domain optical coherence tomography (SD-OCT) as disclosed in Donghak Choi et al. “Fourier domain optical coherence tomography using optical demultiplexers imaging at 60,000,000 lines/s”, Optics Letters, Vol. 33, Issue 12, pp. 1318-1320 (2008). In this method, a spectrometer including a spectroscopic element such as a diffraction grating and a line sensor is used to acquire the optical spectrum interference signal that is developed spatially. With this method, the optical spectrum interference signal may be acquired in a collective manner, so that high-speed imaging may be performed.

As for the sensitivity, the intensity of the optical interference signal is proportional to a product of the intensity of the reference light and the intensity of the return light from the object to be measured, and hence even when the return light from the object to be measured is attenuated due to absorption, scattering, or transmission, the tomographic information signal may be obtained with high sensitivity due to the interference between the return light and the reference light having high intensity.

Further, in order to increase the signal-to-noise ratio (SNR) of the tomographic signal, a detection method called differential detection has been employed in the OCT. Through the differential detection, a component of only the scatter or reflection light or the reference light immediately before the interference is canceled, so that only the interference component may be detected.

As for the resolution (ability to display the layered structure in a resolved manner), as the spectral band of the light output from the light source is broader, a tomographic information signal having high resolution in a depth direction is obtained.

When performing the differential detection in the conventional TD-OCT and SS-OCT described above, it is necessary to provide multiple detectors for detecting light at the same time.

Further, when performing the differential detection of the spectral interference signal in the SD-OCT, it is necessary to provide two spectrometers and two line sensors, resulting in a complex configuration.

Still further, when performing the differential detection of the spectral interference signal by using the two spectrometers, it is necessary that exactly the same spectroscopic conditions be set for the two spectrometers, and that the two line sensors receive light having exactly the same spectra for all pixels that determine the difference. However, such settings are extremely difficult, and hence the differential detection becomes difficult, resulting in difficulty in improving the quality of the tomographic image.

### SUMMARY OF THE INVENTION

The present invention has been made in view of the problems described above, and therefore provides an optical coherence tomography apparatus and an optical coherence tomography method capable of performing differential detection with a simple configuration and without a need to provide multiple spectrometers and detection units.

According to one embodiment of the present invention, there is provided an optical coherence tomography apparatus, including: a light source unit; a branch unit for branching light output from the light source unit into measurement light and reference light; an interference unit for causing one of reflection light and scatter light, the one of the reflection light and the scatter light from an object illuminated with the measurement light with the reference light corresponding to the measurement light; and a detection unit for receiving interference light obtained through the interference performed by the interference unit so as to detect an intensity of the interference light, in which a tomographic image of the object is acquired based on the intensity of the interference light detected by the detection unit, in which the interference unit outputs first interference light and second interference light having interference components having phases mutually different by n, and in which the first interference light and the second interference light output from the interference unit reaches the detection unit so that a time gap is generated between the first interference light and the second interference light.

According to one embodiment of the present invention, there is provided an optical coherence tomography method for causing, by an interference unit, one of reflection light and scatter light, the one of the reflection light and the scatter light being light returned from an object illuminated with measurement light from a light source unit, to interfere with reference light corresponding to the measurement light, receiving interference light obtained through the interference performed by the interference unit so as to detect an intensity of the interference light, and acquiring a tomographic image of the object based on the detected intensity of the interference light, the optical coherence tomography method including: outputting, by the interference unit, first interference light and second interference light having interference components having phases mutually different by n; and receiving the first interference light and the second interference light, which are output from the interference unit, through optical paths having different lengths so that a time gap is generated between the first interference light and the second interference light, to thereby detect an intensity of the first interference light and an intensity of the second interference light having the time gap generated therebetween.

Further features of the present invention will become apparent from the following description of exemplary embodiments with reference to the attached drawings.

### BRIEF DESCRIPTION OF THE DRAWINGS

FIG. 1 is a schematic explanatory diagram illustrating an overview of the configuration of an optical coherence tomography apparatus according to an embodiment of the present invention.

FIGS. 2A, 2B, 2C, and 2D are schematic explanatory diagrams illustrating signal processing to be performed in the optical coherence tomography apparatus according to the embodiment of the present invention.

FIG. 3 is a schematic explanatory diagram illustrating the principle of differential detection to be performed in the optical coherence tomography apparatus according to the embodiment of the present invention.

FIG. 4 is a schematic explanatory diagram illustrating the configuration of an optical coherence tomography apparatus according to a first embodiment of the present invention.

FIG. 5 is a schematic explanatory diagram illustrating the configuration of an optical coherence tomography apparatus according to a second embodiment of the present invention.

FIG. 6 is a schematic explanatory diagram illustrating an overview of the configuration of an optical coherence tomography apparatus according to an embodiment of the present invention.

FIG. 7 is a schematic explanatory diagram illustrating an overview of the configuration of an optical coherence tomography apparatus according to an embodiment of the present invention.

FIG. 8 is a schematic explanatory diagram illustrating an overview of the configuration of an optical coherence tomography apparatus according to an embodiment of the present invention.

### DESCRIPTION OF THE EMBODIMENTS

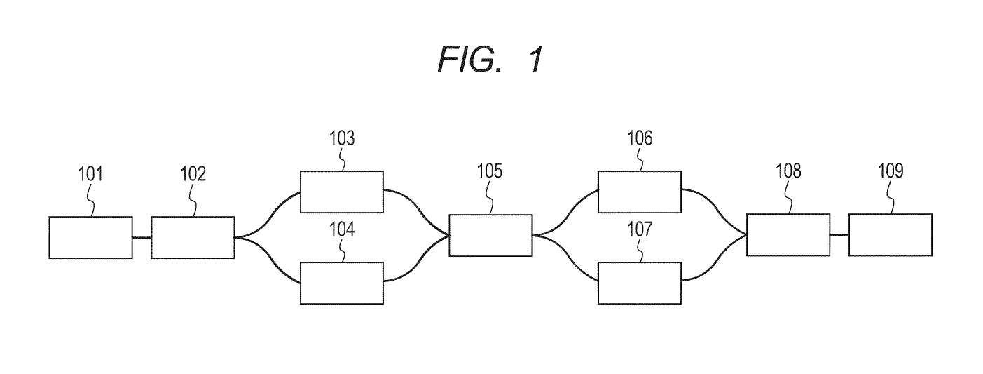

An overview of the configuration of an optical coherence tomography apparatus according to an embodiment of the present invention is described with reference to FIG. 1. As a light source unit 101 of the optical coherence tomography apparatus according to this embodiment, there is used a broadband light source for oscillating light having a broad wavelength band. The broadband light source is typified by a light source such as a lamp light source and a superluminescent diode (SLD) that output light in a temporally intermittent manner, a short pulse light source, and a supercontinum light source (SC light source) that is a short pulse light source for outputting light having a broad spectrum by utilizing a nonlinear optical effect.

The light output from a light source unit 101 as a broadband light source is branched by a branch unit 102 into reference light and illumination light (measurement light) that propagates to a sample (object). The branch unit 102 includes a beam splitter and an optical fiber coupler. The sample is illuminated with the illumination light in a sample illumination unit 103, and reflection light or scatter light is obtained. On the other hand, the reference light propagates through a reference optical path 104.

The reflection or scatter light and the reference light are input to an interference unit 105, and then first interference light and second interference light having interference components having phases mutually different by π are output separately. The interference unit 105 includes an optical fiber coupler and a beam splitter.

The first interference light and the second interference light propagate through a delay unit 106 and a delay unit 107, respectively, so that a time gap is generated between the first interference light and the second interference light to reach a detector (detection unit) 108. The delay unit 106 and the delay unit 107 include an optical fiber and a space. In this case, the time gap to reach the detector 108 only needs to be different from the temporally intermittent period. In the manner described above, the first interference light and the second interference light having the interference components having phases mutually different by π and having the time gap generated therebetween are detected by the detector 108 at different timings.

Through use of a first interference signal and a second interference signal obtained through the detection by the detector 108, a signal processing unit (information acquisition unit) 109 determines a difference therebetween to acquire a differential optical spectrum interference signal having only the interference components.

Through the differential detection described above, non-interference components are attenuated, and thus noise derived from the non-interference components may be reduced. With this configuration, the signal-to-noise ratio (SNR) of the tomographic information signal may be increased.

The differential optical spectrum interference signal thus acquired is subjected to Fourier transform, to thereby acquire a tomographic signal of the sample along the illumination direction of the illumination light. In this case, fast Fourier transform may be employed as the Fourier transform.

The illumination position or direction of the illumination light for the sample is moved in a scanning manner, and the above-mentioned step is repeated for each illumination position or direction, to thereby acquire a tomographic signal. The tomographic signals of the respective illumination positions or directions are arranged to form an image. In this case, the position or direction of the illumination light is moved in a scanning manner through use of a mirror that is changeable in angle, or through movement of the sample.

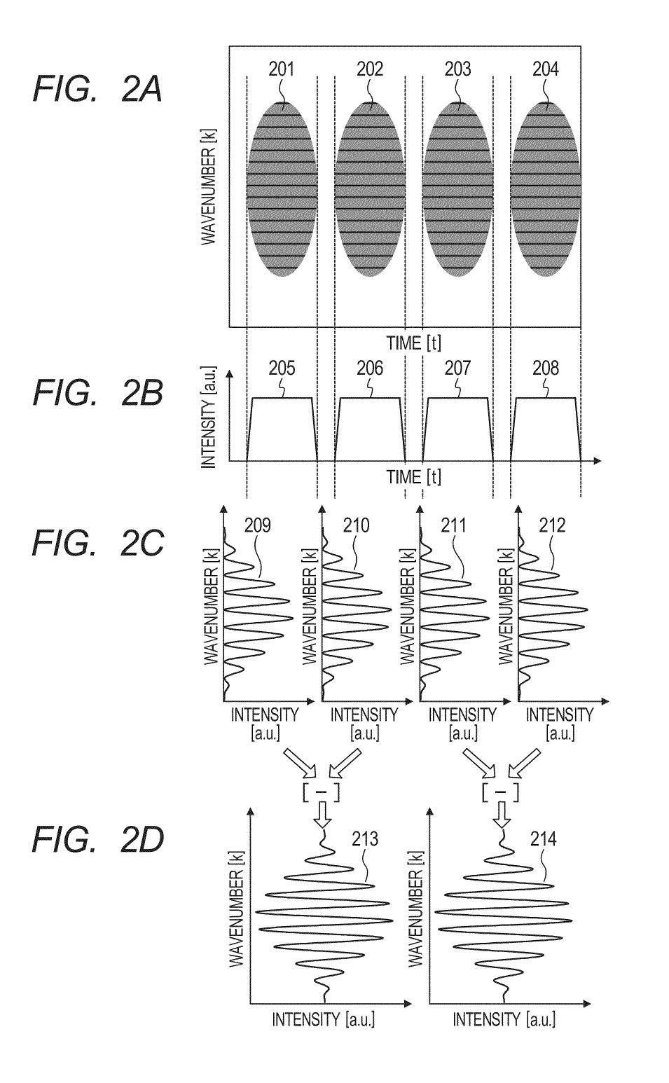

Next, signals to be acquired in this embodiment and signal processing to be performed in this embodiment are described with reference to FIGS. 2A to 2D. FIG. 2A is a spectrogram showing interference signals that are developed along a time axis and a wavenumber axis. FIG. 2B shows temporal changes of the interference signals. FIG. 2C is a graph showing that the interference signals are spectral interference signals. FIG. 2D shows differential optical spectrum interference signals.

The optical coherence tomography apparatus of this embodiment is configured so that first interference light 201 (205, 209) and second interference light 202 (206, 210) having a time gap generated therebetween may reach the detector. Therefore, the first interference light 201 (205, 209) and the second interference light 202 (206, 210) are detected by the detector at different timings. FIG. 2C shows that phases of interference components of the first interference light 201 (205, 209) and the second interference light 202 (206, 210) are mutually different by π. FIG. 2D shows that the signal processing unit determines a difference between a first interference signal and a second interference signal obtained through the detection by the detector to acquire a differential optical spectrum interference signal 213 having only interference components.

As for an interference signal indicating a tomogram for the next illumination position, first interference light 203 (207, 211) and second interference light 204 (208, 212) reach the detector, and a differential optical spectrum interference signal 214 is acquired. The differential optical spectrum interference signal 214 thus acquired is subjected to Fourier transform, to thereby acquire a tomographic signal of the sample along the illumination direction of the illumination light.

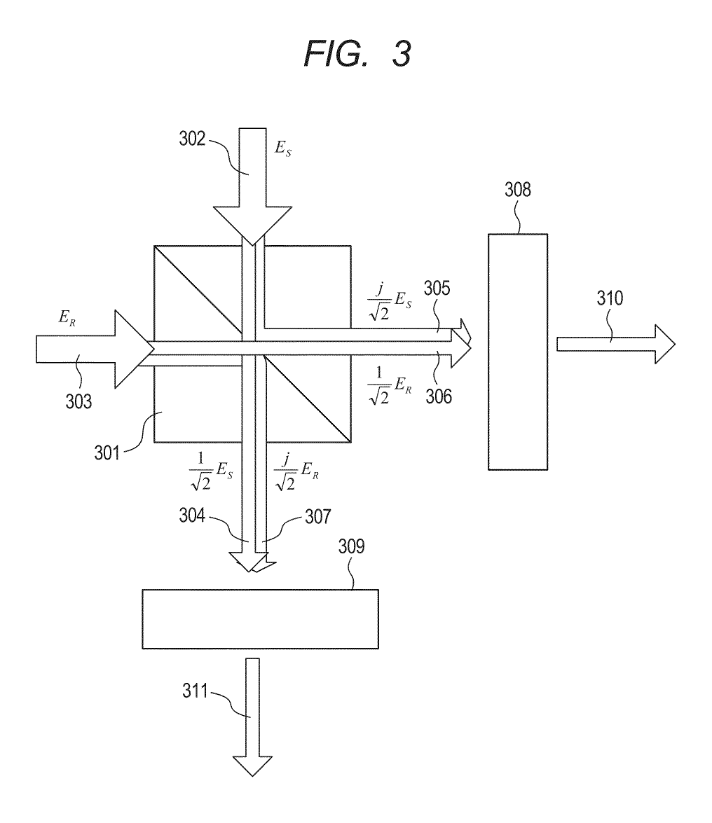

Referring to FIG. 3, the principle of the differential detection to be performed in the optical coherence tomography apparatus of this embodiment is described.

In this case, it is assumed that the interference unit is a beam splitter 301 having a branching ratio of 1:1. Signal light 302 (E_{S}) corresponding to the reflection or scatter light and reference light 303 (E_{R}) are caused to enter the beam splitter 301. At this time, the signal light 302 is split by the beam splitter into transmission light 304 and reflection light 305. Similarly, the reference light 303 is split by the beam splitter into transmission light 306 and reflection light 307.

The reflection light 305 of the signal light 302 and the transmission light 306 of the reference light 303 overlap each other, and the resultant light is detected by a photodetector 308. Thus, a first interference intensity signal 310 is obtained.

Similarly, the transmission light 304 of the signal light 302 and the reflection light 307 of the reference light 303 overlap each other, and the resultant light is detected by a photodetector 309. Thus, a second interference intensity signal 311 is obtained.

The first interference intensity signal 310 and the second interference intensity signal 311 are expressed by Equations (1) and (2), respectively.

$$\begin{matrix}First interference intensity signal ( 310 ) ∝ {\vert \frac{1}{\sqrt{2}} {E}_{R} ( ω ) + \frac{j}{\sqrt{2}} {E}_{S} ( ω ) \vert}^{2} = \frac{1}{2} ( {\vert {E}_{R} ( ω ) \vert}^{2} + {\vert {E}_{S} ( ω ) \vert}^{2} + {jE}_{R}^{*} ( ω ) {E}_{S} ( ω ) - {jE}_{R} ( ω ) {E}_{S}^{*} ( ω ) ) = \frac{1}{2} \{ {\vert {E}_{R} ( ω ) \vert}^{2} + {\vert {E}_{S} ( ω ) \vert}^{2} \} - \{ \vert {E}_{R} ( ω ) \vert \times \vert {E}_{S} ( ω ) \vert \times cos [ ( ( {l}_{AR} - {l}_{AS} ) \frac{ω}{c} ) ] \} & Equation ( 1 ) \\ Second interference intensity signal ( 311 ) ∝ {\vert \frac{j}{\sqrt{2}} {E}_{R} ( ω ) + \frac{1}{\sqrt{2}} {E}_{S} ( ω ) \vert}^{2} = \frac{1}{2} ( {\vert {E}_{R} ( ω ) \vert}^{2} + {\vert {E}_{S} ( ω ) \vert}^{2} - {jE}_{R}^{*} ( ω ) {E}_{S} ( ω ) + {jE}_{R} ( ω ) {E}_{S}^{*} ( ω ) ) = \frac{1}{2} \{ {\vert {E}_{R} ( ω ) \vert}^{2} + {\vert {E}_{S} ( ω ) \vert}^{2} \} + \{ \vert {E}_{R} ( ω ) \vert \times \vert {E}_{S} ( ω ) \vert \times cos [ ( ( {l}_{AR} - {l}_{AS} ) \frac{ω}{c} ) ] \} & Equation ( 2 )\end{matrix}$$

In Equations (1) and (2), “E_{R}” and “E_{S}” represent electric fields of the reference light and the signal light, respectively, “ω” represents an angular frequency, “l_{AR}” represents an optical path length of the reference light, “l_{AS}” represents an optical path length of the signal light, and “c” represents the speed of light. Further, in Equations (1) and (2), the term having the cosine component is a term representing the interference component. The term having the cosine component in Equation (1) and the term having the cosine component in Equation (2) have opposite signs. Therefore, it is understood that the intensities of the interference components are inverted (that is, the phases are mutually different by n). The same applies to the first interference signal obtained by detecting the first interference light 201 and the second interference signal obtained by detecting the second interference light 202 in FIG. 2A.

Next, as expressed by Equation (3), a difference between Equations (1) and (2) is determined. Based on Equation (3), it is understood that only the interference components remain. This signal corresponds to the differential optical spectrum interference signal 213 in FIG. 2D. Thus, the principle of the differential detection has been described above.

$$First interference intensity signal ( 310 ) - Second interference intensity signal ( 311 ) ∝ 2 \cdot \{ \vert {E}_{R} ( ω ) \vert \times \vert {E}_{S} ( ω ) \vert \times cos [ ( ( {l}_{AR} - {l}_{AS} ) \frac{ω}{c} ) ] \} \qquad Equation ( 3 )$$

### First Embodiment

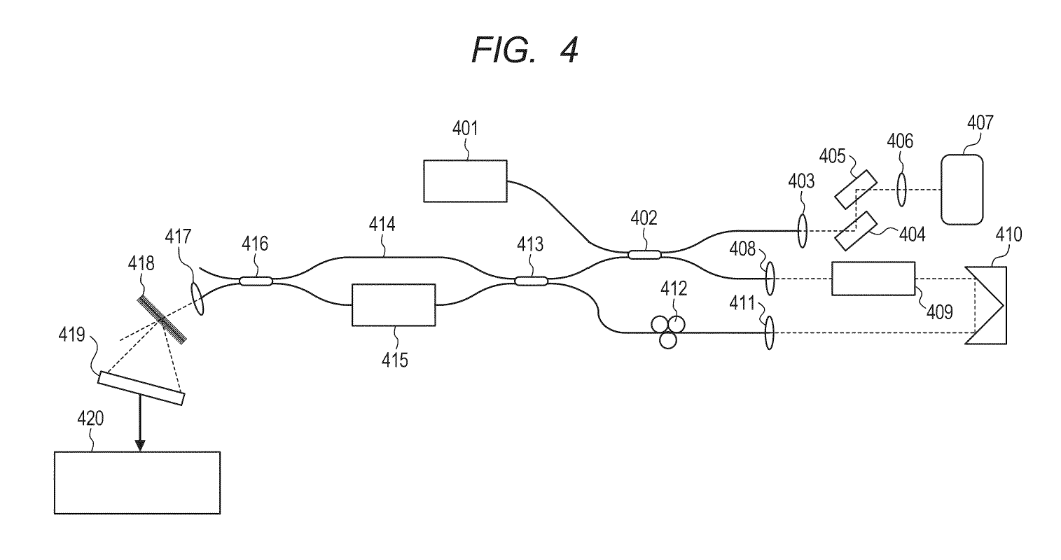

Referring to FIG. 4, a first embodiment of the present invention describes a configuration example in which a light source for outputting light in a temporally intermittent manner (pulsed SC light source, or SLD or lamp using a modulated driving power source) is used as the broadband light source. In this embodiment, as a light source unit 401, there is used a light source for outputting light having a broad wavelength bandwidth in a temporally intermittent manner. For example, a short pulse light source for outputting light having a broad spectral band is used as the light source unit 401. Further, a pulsed SC light source for outputting light having a greatly broad spectral band, or a SLD or a lamp light source driven in a temporally intermittent manner may be used.

The temporally intermittent frequency of the light source is 70 kHz. This value corresponds to a half of 140 kHz, which is a response speed of a line sensor 419 for detecting light. Further, the duty ratio of the intermittent light output is 50%. Thus, the photodetector may detect light without the loss of light.

The effects of the present invention may be attained even when the duty ratio of the intermittent light output is not 50%. When the duty ratio of the intermittent light output is not 50%, it is only necessary to use interference signals detected at timings when the first interference light and the second interference light do not overlap each other. Thus, the error in the response speed of the photodetector may be mitigated.

The OCT interferometer in this embodiment has the following configuration.

The light output from the light source unit 401 is split into illumination light for illuminating a sample and reference light by an optical fiber coupler 402 serving as an optical branch unit.

The reference light is converted into a collimated beam through a lens 408. Then, the reference light propagates an optical path different from the optical path of the light for illuminating a sample 407. That is, the reference light propagates through a dispersion compensation unit 409 for adjusting wavelength dispersion, and through an optical delay line 410 for adjusting the optical path length, and is coupled again to the optical fiber through a lens 411. The reference light coupled to the optical fiber propagates through an optical fiber polarization controller 412 so that the polarization state is adjusted. Then, the reference light is guided to an optical fiber coupler 413.

On the other hand, the illumination light for illuminating the sample 407 is converted into a collimated beam through a lens 403, and propagates through an optical system including two galvano mirrors 404 and 405 arranged orthogonal to each other, for moving the illumination direction in a scanning manner. Then, the illumination light illuminates the sample 407 through a sample illumination optical system 406 so as to obtain a beam propagation profile in accordance with the sample 407. The return light after illuminating the sample 407 to be scattered or reflected therefrom propagates to the optical fiber again, and further propagates through the optical fiber coupler 402 to the optical fiber coupler 413.

In the optical fiber coupler 413, the scatter or reflection light from the sample 407 and the reference light overlap each other to generate interference light. When the interference light output from two output terminals of the optical fiber coupler 413 are detected, there are obtained intensity signals having non-interference components at the same intensities and interference components at inverted intensities.

The optical delay line 410 is adjusted so that the optical path length of the reference light and the optical path length of the light which illuminates the sample 407 and is reflected by the sample 407 are substantially equal to each other in a range from the optical fiber coupler 402 that branches the light into the reference light and the illumination light to the optical fiber coupler 413 that generates the interference light.

Further, the direction of the illumination light is controlled by the two galvano mirrors 404 and 405, and the illumination light scans one line on the sample 407 within 14.63 ms. Thus, tomographic information signals in approximately 1,024 directions are obtained.

A configuration and method for generating a time gap between the two interference light beams are described.

One of the two interference light is propagated through an optical path 414, and the other is propagated through an optical delay line 415, to thereby generate the time gap between the two interference light. In this case, the optical delay line 415 is formed of an optical fiber having a refractive index of approximately 1.45. In order to delay the light by 7.14 μs corresponding to a half of 14.28 μs, which is a period corresponding to 70 kHz, the length of the optical fiber is set to 1.48 km. With the time gap, the two interference light are each output within a period corresponding to the half of the temporally intermittent period of the light source.

Further, the time gap in this case does not need to be 7.14 μs exactly. In that case, it is only necessary to acquire signals so that the first interference light and the second interference light do not temporally overlap each other. In this manner, the error in the length of the optical delay line may be mitigated.

A method of propagating the temporally-shifted interference light through the same optical path is described. The two interference light having the time gap generated therebetween are coupled to each other by an optical fiber coupler 416 serving as an optical coupling unit. As the optical coupling unit, there may be used an optical coupler utilizing an optical switch and a diffraction element or an optical coupler utilizing polarization. Through use of the optical coupler utilizing an optical switch and a diffraction element or the optical coupler utilizing polarization, the loss of light that may exit from one of the two output terminals of the optical fiber coupler can be eliminated.

Then, the two interference light are detected under the same spectroscopic conditions in the following manner, to thereby perform the differential detection. The two interference light having the time gap generated therebetween and passing through the same optical path by the optical coupling unit are converted into collimated beams through a lens 417. Then, the two interference light are spatially dispersed by a transmissive diffraction grating (wavelength dispersion element) 418 in accordance with the wavelength, and are received by the line sensor 419. The response speed of the line sensor 419 is 140 kHz, and the two interference light having the time gap generated therebetween are detected by the line sensor 419 at 7.14 μs intervals. Thus, the interference signals of the two interference light having the time gap generated therebetween are detected at different timings. The two interference signals thus detected are received into a personal computer (PC) 420, and a difference is determined therebetween. Thus, the non-interference components may be canceled and only the interference components may be acquired.

The interference components thus acquired are subjected to Fourier transform in the following manner, to thereby acquire tomographic information. That is, the interference components acquired by the PC 420 are rearranged on the wavenumber axis instead of the wavelength axis, and the Fourier transform is performed. Thus, a tomographic signal in which noise components due to the non-interference components are canceled is obtained.

The tomographic signal in this case is a tomographic signal of the sample along the illumination direction of the illumination light. A single tomographic signal may be acquired in the temporally intermittent period of the light source. Then, the two galvano mirrors 404 and 405 are caused to scan one line on the sample within 14.63 ms, to thereby obtain tomographic information signals in approximately 1,024 directions. The tomographic information signals in the 1,024 directions are arranged to obtain a single tomographic image.

According to the above-mentioned configuration of this embodiment, the differential detection may be performed in the SD-OCT, and thus the quality of the tomographic image may be improved.

### Second Embodiment

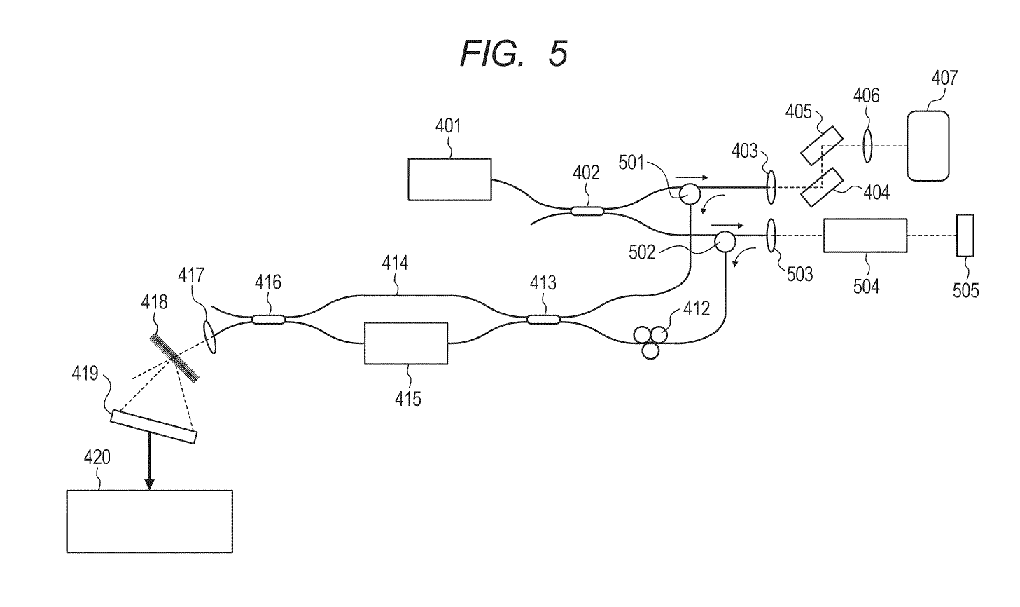

Referring to FIG. 5, a second embodiment of the present invention describes a configuration example using circulators. A light source unit of an optical coherence tomography apparatus in this embodiment has a similar configuration to that of the first embodiment. Therefore, in FIG. 5, the same members as those described with reference to FIG. 4 are represented by the same reference symbols, and redundant description is omitted herein.

The OCT interferometer in this embodiment has the following configuration.

The light output from the light source unit 401 is split into the illumination light for illuminating the sample and the reference light by the optical fiber coupler 402 serving as the optical branch unit. The reference light propagates through an optical fiber circulator 502 toward an optical delay line 505. Then, the reference light is converted into a collimated beam through a lens 503. Then, the reference light propagates an optical path different from the optical path of the light for illuminating the sample 407. That is, the reference light propagates through a dispersion compensation unit 504 for adjusting wavelength dispersion, and through the optical delay line 505 for adjusting the optical path length, and is reflected and coupled again to the optical fiber through the lens 503. The reference light coupled to the optical fiber propagates through the optical fiber circulator 502 again, and further propagates through the optical fiber polarization controller 412. Then, the reference light is guided to the optical fiber coupler 413.

On the other hand, the illumination light for illuminating the sample 407 propagates through an optical fiber circulator 501 toward the sample 407. The illumination light is converted into a collimated beam through the lens 403, and propagates through the optical system including the two galvano mirrors 404 and 405 arranged orthogonal to each other, for moving the illumination direction in a scanning manner. Then, the illumination light illuminates the sample 407 through the sample illumination optical system 406 so as to obtain a beam propagation profile in accordance with the sample 407. The return light after illuminating the sample 407 to be scattered or reflected therefrom is coupled to the optical fiber again, and propagates through the optical fiber circulator 501 again. Then, the return light is guided to the optical fiber coupler 413. In the optical fiber coupler 413, the scatter or reflection light from the sample 407 and the reference light overlap each other to generate interference light.

When the interference light output from the two output terminals of the optical fiber coupler 413 are detected, there are obtained intensity signals having the non-interference components at the same intensities and the interference components at inverted intensities.

The optical delay line 505 is adjusted so that the optical path length of the reference light and the optical path length of the light which illuminates the sample 407 and is reflected by the sample 407 are substantially equal to each other in the range from the optical fiber coupler 402 that branches the light into the reference light and the illumination light to the optical fiber coupler 413 that generates the interference light beams.

Further, the direction of the illumination light is controlled by the two galvano mirrors 404 and 405, and the illumination light scans one line on the sample 407 within 14.63 ms. Thus, tomographic information signals in approximately 1,024 directions are obtained.

Further, a configuration and the like for generating a time gap between the above-mentioned two interference light signals to acquire a tomographic image are similar to those of the first embodiment.

According to the above-mentioned configuration of this embodiment, the scatter or reflection light from the sample and the reference light may be caused to interfere with each other without returning the scatter or reflection light toward the light source. Thus, most of the scatter or reflection light from the sample may be utilized to generate the interference light.

### Third Embodiment

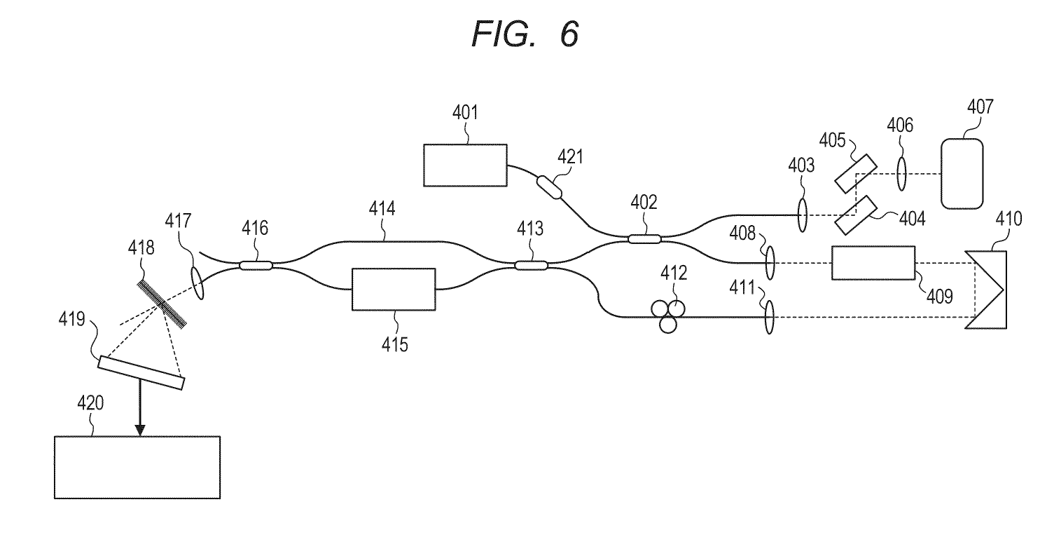

A third embodiment of the present invention describes a configuration example in which an intensity modulation unit 421 for outputting light in an intermittent manner is provided between the light source unit 401 and the branch unit 402 as shown in FIG. 6, and the other components are set identical to those of the first and second embodiments. As a light source unit of an optical coherence tomography apparatus in this embodiment, there is used a light source for outputting light having a broad wavelength bandwidth. For example, the light source unit is a SLD. Further, there may be used a lamp light source, a short pulse light source for outputting light having a broad spectral band at a pulse repetition frequency higher than an intensity modulation frequency (70 kHz) of an intensity modulator (intensity modulation unit) described later, and a pulsed SC light source for outputting light having a greatly broad spectral band.

In this embodiment, the light output from the light source is caused to pass through the intensity modulator so as to be output in a temporally intermittent manner. The intensity modulator 421 is, for example, an electro-optic modulator (EOM). Further, an acousto-optic modulator (AOM) and a photochopper may be used as the intensity modulator 421.

The temporally intermittent frequency of the light source is 70 kHz. This value corresponds to a half of 140 kHz, which is the response speed of the line sensor 419 for detecting light. Further, the duty ratio of the intermittent light output is 50%. Thus, the photodetector may detect light without the loss of light.

The effects of the present invention may be attained even when the duty ratio of the intermittent light output is not 50%. When the duty ratio of the intermittent light output is not 50%, it is only necessary to use interference signals detected at timings when the first interference light and the second interference light do not overlap each other. Thus, the error in the response speed of the photodetector may be mitigated.

According to the above-mentioned configuration of this embodiment, a light source for outputting light other than pulsed light may be used.

### Fourth Embodiment

A fourth embodiment of the present invention describes a configuration example in which intensity modulation units 421, 422 for outputting light in an intermittent manner are provided between the branch unit 402 and the interference unit 413 for outputting interference light, and the other components are set identical to those of the first and second embodiments. A broadband light source in this embodiment has a similar configuration to that of the third embodiment. Further, in this embodiment, intensity modulators are inserted into optical paths formed in the following manner.

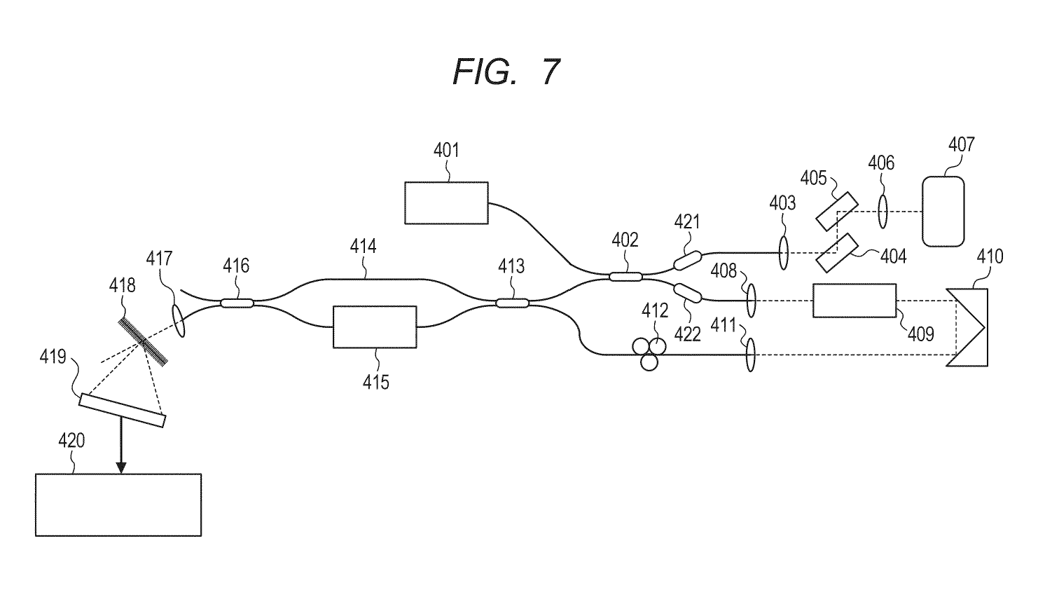

That is, light intensity modulators 421, 422 are inserted into the optical path for propagating the light through the sample 407 and the optical path for propagating the light through the optical delay line in a range between the optical fiber coupler 402 that branches the light into the illumination light and the reference light and the optical fiber coupler 413 that causes the interference as shown in FIG. 7. Further, the temporally intermittent frequency of the light source that is attained by the light intensity modulator in each optical path is 70 kHz. This value corresponds to a half of 140 kHz, which is the response speed of the line sensor 419 for detecting light. Still further, the two light intensity modulators 421, 422 inserted so as to generate the interference signals are synchronized with each other.

According to the above-mentioned configuration of this embodiment, a light source for outputting light other than pulsed light may be used.

Further, when the light intensity modulator 421 is provided in the optical path in a range between the optical fiber coupler 402 and the sample 407, the intensity of light for illuminating the sample 407 may be adjusted.

### Fifth Embodiment

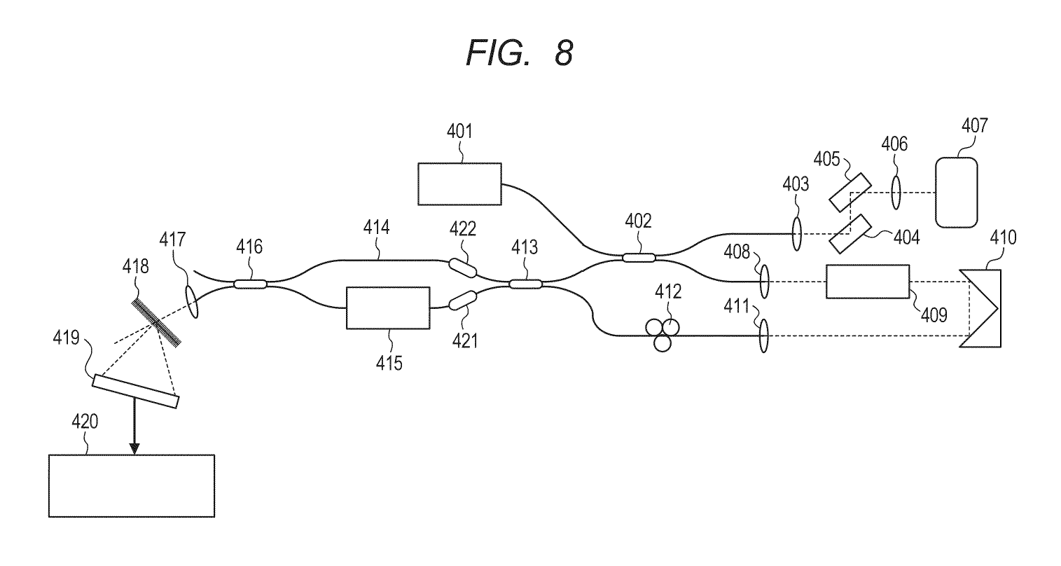

A fifth embodiment of the present invention describes a configuration example in which the intensity modulation units 421, 422 for outputting light in an intermittent manner are provided between the interference unit 413 for outputting interference light and the detection unit as shown in FIG. 8. Note that, in this embodiment, the configuration of, for example, the interference unit for overlapping the scatter or reflection light from the sample with the reference light is the same as that of the first and second embodiments. Further, a broadband light source in this embodiment has a similar configuration to that of the third embodiment. Still further, in this embodiment, intensity modulators are inserted into parts for generating a time gap between the interference light in the following manner.

One of the two interference light obtained by the interference unit 413 is propagated through the light intensity modulator 421 so as to be output in a temporally intermittent manner at a frequency of 70 kHz. Then, the light is guided to the optical delay line 415. Then, through the optical delay line 415, a time gap is generated between the two interference light. In this case, the optical delay line 415 is formed of an optical fiber having a refractive index of approximately 1.45. In order to delay the beam by 7.14 μs corresponding to a half of 14.28 μs, which is the period corresponding to 70 kHz, the length of the optical fiber is set to 1.48 km.

The time gap in this case does not need to be 7.14 μs exactly. In that case, it is only necessary to acquire signals so that the first interference light and the second interference light do not temporally overlap each other. In this manner, the error in the length of the optical delay line may be mitigated.

The other of the two interference light is propagated through the other light intensity modulator 422 so as to be output in a temporally intermittent manner at a frequency of 70 kHz.

The two interference light output in a temporally intermittent manner and having the time gap generated therebetween are propagated through the optical fiber coupler 416 serving as the optical coupling unit so as to be coupled to each other. In this case, the light intensity modulator on the delaying side may be placed not only in the front of the optical delay line but also in the optical delay line or in the rear of the optical delay line. Further, the two light intensity modulators 421, 422 are synchronized with each other so as to prevent the two interference light from reaching the optical fiber coupler serving as the optical coupling unit at the same time.

According to the above-mentioned configuration of this embodiment, a light source for outputting light other than pulsed light may be used.

### Sixth Embodiment

A sixth embodiment of the present invention describes a configuration example in which a wavelength-swept pulse light source is used to determine a difference for each pulse. Note that, in this embodiment, the configuration of, for example, the interference unit for overlapping the scatter or reflection light from the sample with the reference light is similar to that of the first and second embodiments. As a light source unit of an optical coherence tomography apparatus in this embodiment, a wavelength-swept pulse light source is used. The wavelength-swept pulse light source is a dispersion-tuning fiber laser that performs light intensity modulation in a resonator having different free spectral ranges (FSR) for the respective wavelengths, and changes the intensity modulation frequency, to thereby change the wavelength of light to be output. Further, there may be used a wavelength-tunable solution pulse light source and a broadband light source for outputting light in a temporally intermittent manner while being switched in its wavelength through use of a filter when the light passes therethrough. The pulse repetition frequency of the wavelength-swept pulse light source is set to 410 MHz as a typical value of the dispersion-tuning fiber laser, and the frequency of a single wavelength sweeping operation is set to 100 kHz. Thus, approximately 4,100 signals having different wavenumbers may be obtained.

In this embodiment, the following configuration is employed so as to generate a time gap between the two interference light obtained by the interference unit. One of the two interference light is propagated through the optical delay line to generate a time gap between the two interference light. In this case, the optical delay line is formed of an optical fiber having a refractive index of approximately 1.45. In order to delay the light by 1.19 ns corresponding to 820 MHz, which is twice as large as 410 MHz, the length of the optical fiber is set to 246 mm.

Then, the interference light thus shifted temporally are propagated through the same optical path in the following manner. The two interference light having the time gap generated therebetween are coupled to each other by the optical fiber coupler serving as the optical coupling unit. As the optical coupling unit, there may be used an optical coupler utilizing an optical switch and a diffraction element or an optical coupler utilizing polarization. Through use of the optical coupler utilizing an optical switch and a diffraction element or the optical coupler utilizing polarization, the loss of light that may exit from one of the two output terminals of the optical fiber coupler may be eliminated.

Further, the two interference light are detected under the same spectroscopic conditions in the following manner, to thereby perform the differential detection. The two interference light having the time gap generated therebetween and passing through the same optical path by the optical coupling unit are detected by the photodetector. The response speed of the photodetector is 820 MHz, which is equal to the pulse repetition frequency of the interference light coupled to each other. Then, as the interference signals of the two interference light having the time gap generated therebetween, pulses having the same center wavelength are detected at different timings. The two interference signals thus detected are received into the PC, a difference is determined between the interference signals having the same frequency. Thus, the non-interference components may be canceled and only the interference components may be acquired.

In this embodiment, Fourier transform is performed in the following manner to acquire tomographic information. The interference components acquired by the PC are rearranged on the wavenumber axis, and the Fourier transform is performed. Thus, a tomographic signal in which noise components due to the non-interference components are canceled is obtained. The tomographic signal in this case is a tomographic signal of the sample along the illumination direction of the illumination light. Further, in order to arrange the components on the wavenumber axis, a wavelength-swept pulse light source in which the center wavelength of the wavelength-swept pulses output therefrom changes at equal wavenumber intervals is used. Alternatively, wavenumber information may be acquired through use of a unit for monitoring the wavenumber based on a Mach-Zehnder interferometer, and the components may be rearranged on the wavenumber axis based on the wavenumber information thus acquired.

In this manner, a single tomographic signal may be acquired through a single wavelength sweeping operation, and the two galvano mirrors provided inside the interferometer are caused to scan one line on the sample within 10.24 ms, to thereby obtain tomographic information signals in approximately 1,024 directions. The tomographic information signals in the 1,024 directions are arranged to obtain a single tomographic image.

According to the above-mentioned configuration of this embodiment, the differential detection may be performed through use of a single photodetector. Further, high-speed optical detection may be performed, and the optical delay line may be shortened.

### Seventh Embodiment

A seventh embodiment of the present invention describes a configuration example using a wavelength-swept light source including a light source that does not output pulsed light to determine a difference for each sweeping operation. Note that, in this embodiment, the configuration of, for example, the interference unit for overlapping the scatter or reflection light from the sample with the reference light is the same as that of the first and second embodiments. As a light source unit of an optical coherence tomography apparatus in this embodiment, a wavelength-swept light source is used. In the wavelength-swept light source, light is developed spatially through use of a diffraction grating, and a part of the light having a specific wavelength is output through movement of a slit-shaped mirror. Further, as the wavelength-swept light source, there may be used a light source in which light is output from a broadband gain medium and a part of the light having a specific wavelength is output through use of a spectral filter such as a Fabry-Perot tunable filter, a diffraction grating, a ring cavity, and a fiber Bragg grating. Alternatively, there may be used a light source in which light is developed spatially through use of a diffraction grating and a part of the light having a specific wavelength is output through use of a rotating polygon mirror. Still alternatively, there may be used a light source in which broadband light is developed temporally through use of a dispersive medium. Still alternatively, the light source described in the sixth embodiment may be used as the wavelength-swept light source.

The period of a single wavelength sweeping operation is set to 10 μs (that is, the frequency is 100 kHz), and a time required to complete a single wavelength sweeping operation is set to 5 μs. That is, the wavelength-swept light source has a duty ratio of 50% at a frequency of 100 kHz. Thus, the photodetector may detect light without the loss of light.

The effects of the present invention may be attained even when the duty ratio of the wavelength-swept light source is not 50%. When the duty ratio of the wavelength-swept light source is not 50%, it is only necessary to use interference signals detected at timings when the first interference light and the second interference light do not overlap each other. Thus, the error in the sweeping speed of the wavelength-swept light source is mitigated.

In this embodiment, the following configuration is employed so as to delay one of the interference light obtained by the interference unit. One of the two interference light is propagated through the optical delay line to generate a time gap between the two interference light. In this case, the optical delay line is formed of an optical fiber having a refractive index of approximately 1.45. In order to delay the light by 5 μs corresponding to a half of 10 μs, which is the period of a single wavelength sweeping operation, the length of the optical fiber is set to 1.03 km.

The time gap in this case does not need to be 5 μs exactly. In that case, it is only necessary to adjust the time gap in accordance with the period of the wavelength sweeping operation and the duty ratio of the wavelength-swept light source, to thereby acquire signals so that the first interference light and the second interference light do not temporally overlap each other. In this manner, the error in the length of the optical delay line may be mitigated.

Further, the interference light thus shifted temporally are propagated through the same optical path in the following manner. The two interference light having the time gap generated therebetween are coupled to each other by the optical fiber coupler serving as the optical coupling unit. As the optical coupling unit, there may be used an optical coupler utilizing an optical switch and a diffraction element or an optical coupler utilizing polarization. Through use of the optical coupler utilizing an optical switch and a diffraction element or the optical coupler utilizing polarization, the loss of light that may exit from one of the two output terminals of the optical fiber coupler may be eliminated.

The configuration and the like for subsequently performing differential detection and acquiring a tomographic image are similar to that of the sixth embodiment.

According to the above-mentioned configuration of this embodiment, the differential detection may be performed through use of a single photodetector. Further, high-speed optical detection may be performed, and the optical delay line may be shortened. Further, a wavelength-swept light source for outputting light other than pulsed light may be used.

According to the present invention, an optical coherence tomography apparatus and an optical coherence tomography method capable of performing differential detection with a simple configuration and without a need to provide multiple spectrometers and detection units may be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-242529, filed Nov. 2, 2012, which is hereby incorporated by reference herein in its entirety.

What is claimed is:

1. An optical coherence tomography apparatus, comprising:
a light source unit;
a branch unit arranged to branch light output from the light source unit into measurement light and reference light;
an interference unit arranged to cause one of reflection light and scatter light, the one of the reflection light and the scatter light being light returned from an object illuminated with the measurement light, to interfere with the reference light corresponding to the measurement light; and
a detection unit arranged to receive the interference light obtained through the interference performed by the interference unit so as to detect an intensity of the interference light,
wherein a tomographic image of the object is acquired based on the intensity of the interference light detected by the detection unit,
wherein the interference unit outputs first interference light and second interference light having interference components having phases mutually different by π, and
wherein the first interference light and the second interference light output from the interference unit reaches the detection unit so that a time gap is generated between the first interference light and the second interference light.

2. An optical coherence tomography apparatus according to claim 1, wherein the first interference light and the second interference light output from the interference unit are received by the detection unit through optical paths having different lengths.

3. An optical coherence tomography apparatus according to claim 1, further comprising a dispersion element arranged to disperse the light in accordance with a wavelength, provided between the interference unit and the detection unit.

4. An optical coherence tomography apparatus according to claim 1, further comprising an optical coupling unit arranged to couple the first interference light and the second interference light having the time gap generated therebetween and propagate the first interference light and the second interference light through the same optical path, provided between the interference unit and the detection unit.

5. An optical coherence tomography apparatus according to claim 1, wherein the light source unit is a wavelength-swept light source, which changes a wavelength temporally.

6. An optical coherence tomography apparatus according to claim 5, further comprising an optical coupling unit arranged to couple the first interference light and the second interference light having the time gap generated therebetween and propagate the first interference light and the second interference light through the same optical path, provided between the interference unit and the detection unit.

7. An optical coherence tomography apparatus according to claim 1, further comprising an information acquisition unit configured to acquire the first interference light and the second interference light having the time gap generated therebetween, detected by the detection unit, and acquire information on the object based on a signal obtained by determining a difference between an intensity of the first interference light and an intensity of the second interference light.

8. An optical coherence tomography apparatus according to claim 1, wherein the light source unit comprises a light source that outputs the light in a temporally intermittent manner.

9. An optical coherence tomography apparatus according to claim 1, further comprising an intensity modulation unit arranged to output the light in a temporally intermittent manner, provided between the light source unit and the branch unit.

10. An optical coherence tomography apparatus according to claim 1, further comprising an intensity modulation unit arranged to output the light in a temporally intermittent manner, provided between the branch unit and the interference unit that outputs the first interference light and the second interference light.

11. An optical coherence tomography apparatus according to claim 1, further comprising an intensity modulation unit arranged to output the light in a temporally intermittent manner, provided between the interference unit that outputs the first interference light and the second interference light and the detection unit.

12. An optical coherence tomography apparatus according to claim 8, wherein the first interference light and the second interference light are alternatively output within a period corresponding to a half of a period of the light output in the temporally intermittent manner.

13. An optical coherence tomography apparatus according to claim 8, wherein the time gap generated between the first interference light and the second interference light to reach the detection unit is a period corresponding to a half of a period of the light output in the temporally intermittent manner.

14. An optical coherence tomography method for causing, by an interference unit, one of reflection light and scatter light, the one of the reflection light and the scatter light being light returned from an object illuminated with measurement light from a light source unit, to interfere with reference light corresponding to the measurement light, receiving interference light obtained through the interference performed by the interference unit so as to detect an intensity of the interference light, and acquiring a tomographic image of the object based on the detected intensity of the interference light,
the optical coherence tomography method comprising:
outputting, by the interference unit, first interference light and second interference light having interference components having phases mutually different by π; and
receiving the first interference light and the second interference light, which are output from the interference unit, through optical paths having different lengths so that a time gap is generated between the first interference light and the second interference light, to thereby detect an intensity of the first interference light and an intensity of the second interference light having the time gap generated therebetween.

15. An optical coherence tomography method according to claim 14, further comprising acquiring the first interference light and the second interference light having the time gap is generated therebetween, and acquiring information on the object based on a signal obtained by determining a difference between the intensity of the first interference light and the intensity of the second interference light.
